(19) United States
(12) Patent Application Publication
(10) Pub. No.: US 2020/0263858 A1
(43) Pub. Date: Aug. 20, 2020

(54) SILICONE OPTICS INSERT MOLDED ON RIGID FRAME

(71) Applicant: CoreLED Systems, LLC, Livonia, MI (US)

(72) Inventors: Derek Mallory, Northville, MI (US); Brian Wells, Grosse Pointe Farms, MI (US); John Kahl, Troy, MI (US)

(73) Assignee: CoreLED Systems, LLC, Livonia, MI (US)

(21) Appl. No.: 16/275,828

(22) Filed: Feb. 14, 2019

(51) Int. Cl. F21V 17/00; F21V 5/00

(52) U.S. Cl. CPC F21V 17/00; F21Y 2115/10; F21V 5/007

(57) ABSTRACT

A lens member for an LED lighting fixture having a plurality of LED dies mounted on a substrate includes a planar frame having a plurality of apertures and an optically transparent silicone rubber overmolded on a first side of the frame. The overmolded silicone rubber defines a plurality of optical elements. Each optical element is disposed within one of the apertures and is shaped to focus or redirect light transmitted through the optical element.

### CROSS-REFERENCE TO RELATED APPLICATIONS

Not Applicable.

### FIELD OF THE DISCLOSURE

This disclosure relates to lighting fixtures and lens members for lighting fixtures, and more particularly to LED lighting fixtures comprising a plurality of LED dies mounted on a substrate, and lens members having a plurality of optical elements that correspond with the plurality of LED dies on a substrate carrying multiple LEDs.

### BACKGROUND OF THE DISCLOSURE

LED lighting fixtures are rapidly replacing incandescent, high intensity discharge, and even fluorescent lighting on account of their lower energy requirements, lighter weight and compact design, which facilitates easier installation and maintenance, and excellent lighting characteristics. Purchasers of high intensity lighting are exhibiting a preference for smaller, lighter in weight multiple LED fixtures for street lighting, parking lot lighting, billboard lighting, fuel station lighting, and similar applications. As a result, smaller LED dies are being mounted in large arrays on a relatively small substrate (e.g., 144 LEDs on a 5 inch by 5 inch substrate).

Efforts to injection mold thermoplastic lens members having a plurality of optical elements, each corresponding with one of the LEDs in the array to direct the light from the LEDs into a uniform pattern on an area targeted for illumination have not been entirely satisfactory. Specifically, it has found that it is difficult to achieve the required dimensional accuracy needed to produce individual optical elements that redirect light as needed to achieve a uniform, low-glare illumination pattern, with the defects being generally unacceptable for those optical elements that are farthest from the injection molding gate. This effect is primarily due to the difficulty of maintaining high pressures farther from the gate, and also due to a tendency for thermoplastic materials to shrink away from mold surfaces as they cool and solidify.

Other attempts to overcome this problem have involved separately molding each individual lens element and installing the lens elements on a frame. This technique can provide greater dimensional accuracy and produce excellent illumination patterns. However, the process involves several steps, greatly increasing labor, production time, and tool and machine expenses, rendering it economically impractical for many municipal, industrial and commercial applications.

The inventors considered casting or injection molding the lens member in a single shot using silicone (polysiloxane) rubber. While excellent dimensional accuracy could be obtained for each of the lens elements in the array, it was determined that the concept was impractical because of difficulty handling, positioning and attaching the silicone rubber lens member to a substrate carrying a plurality of LEDs, due to the flexibility and softness of the silicone rubber.

### SUMMARY OF THE DISCLOSURE

In certain aspects, this disclosure is directed to lens members for LED lighting fixtures that include a plurality of lens members or optical members, each corresponding to an LED mounted on a substrate. The lens member includes a planar frame having a plurality of apertures, and an optically transparent silicone rubber overmolded on a first side of the planar frame. The overmolded silicone rubber defines a plurality of optical elements, each of which is disposed with one of the apertures. Each optical element is shaped to focus or redirect light transmitted through the optical element.

In certain embodiments, the planar frame is relatively rigid or inflexible relative to the silicone rubber. Preferably, the frame has a flexural modulus of about 375,000 psi or greater.

The silicone rubber used to overmold the frame is preferably heat curable at a temperature of about 140° C. to about 170° C. to provide short cycle times. As a consequence, the frame should be capable of withstanding relatively high temperatures during the cure. Suitable frame materials include metals such as steel, aluminum, stainless steel, etc., as well as thermoplastic materials having a glass transition temperature greater than 130° C., 145° C. or 150° C.

In certain aspects or embodiments, the frame comprises a transparent or translucent thermoplastic that allows some of the light from LEDs in an illuminated lighting fixture to pass through the frame to reduce the perception of glare and spread the light more uniformly.

A suitable and preferred thermoplastic material for fabricating the frame is polycarbonate, which can be either transparent or translucent.

In accordance with certain other aspects of this disclosure, an LED lighting fixture is provided. The fixture includes a plurality of LED dies mounted on a substrate, and a lens member as described above, wherein the lens member is arranged over (overlays) the LED dies such that each optical element is positioned over a corresponding LED die.

In accordance with a further aspect of this disclosure, there is provided a process of making a lens member for an LED lighting fixture using steps of providing a planar frame having a plurality of apertures, and overmolding a first side of the planar frame with an optically transparent silicone rubber to form a plurality of optical elements, wherein each optical element is disposed within one of the apertures, and each optical element is shaped to redirect light transmitted through the optical member.

### BRIEF DESCRIPTION OF THE DRAWINGS

FIG. 1 is a perspective view of a lens member for an LED lighting fixture in accordance with certain aspects of this disclosure.

FIG. 2 is a perspective view of a planar frame having a plurality of apertures for use in fabricating the member shown in FIG. 1.

FIG. 3 is a cross-sectional side view of the lens member shown in FIG. 1.

FIG. 4 is a perspective view of an LED lighting fixture having a plurality of LEDs mounted on a substrate, with a portion of an overlying lens member broken away to show the underlying LEDs and substrate.

FIG. 5 is a cross-sectional view of a mold containing a planar frame that was placed in the mold cavity, an overmolded on one side with a silicone rubber to form a plurality of optical elements (i.e., lens) that focus or redirect light.

### DETAILED DESCRIPTION

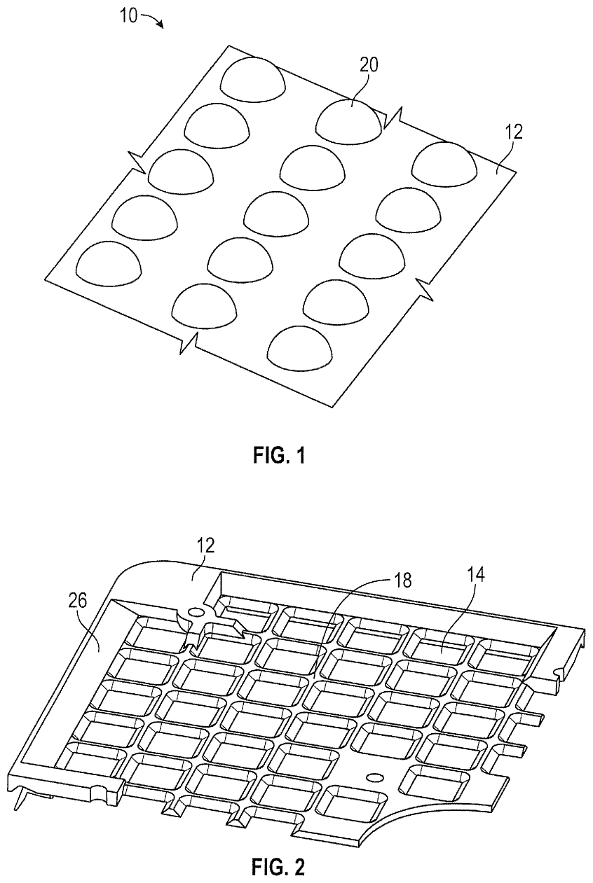

Shown in FIG. 1 is a lens member 10 for use in a lighting fixture employing light emitting diodes (LEDs). The lens member includes a planar frame 12 having a plurality of apertures 14 (FIG. 2). The frame 12 provides a relatively rigid base onto which a highly flexible silicone rubber body 16 is overmolded. Frame 12 facilitates handling, locating and attaching lens member 10 to a lighting fixture, it being relatively more difficult to properly position and attach a highly flexible silicone body to a lighting fixture when the silicone body is not rigidly supported. Accordingly, frame 12 is preferably made using a material having a flexural modulus that is greater than that of the silicone rubber body 16. The flexural modulus of silicone rubber typically ranges from about 150 psi to about 7500 psi. The material used to fabricate frame 12 preferably has a flexural modulus at least one order of magnitude greater than that of the silicone rubber body 16, e.g., greater than 75,000 psi, greater than or equal to 375,000 psi, or greater than 500,000 psi. Suitable materials include metals such as steel, stainless steel, and aluminum; and thermoplastics such as polycarbonates, polyacrylates (acrylic polymers), cellulose acetates, polyetherimides, and high impact polystyrene. The material selected to fabricate the frame should be capable of withstanding the relatively high temperatures required to thermally cure the overmolded silicone rubber body 16. Typical cure temperatures are from about 140° C. to about 170° C. for silicone rubbers. Accordingly, when thermoplastics are used for fabricating frame 12, it is desirable that the selected thermoplastic material has a glass transition temperature that is greater than the cure temperature, e.g., greater than or equal to 130° C., greater than or equal to 145° C., or greater than or equal to 150° C. The frame 12 can typically have a thickness of from about 0.5 mm to about 4 mm. In general, thinner frames are possible when the frame is metal.

Preferably, frame 12 is transparent or translucent to allow some light from LEDs underlying the lens member 10 to pass through the grid 18 of frame 12 that defines apertures 14. This has the effect of reducing the perception of glare. For purposes of this disclosure, we define perceived glare as the tendency for an observer to see a larger more uniform after image when the observer closes her/his eyes after looking directly at the light source, rather than a field of individual spots. Preferred thermoplastics include transparent or translucent acrylics and polycarbonates having a glass transition temperature of at least about 130° C.

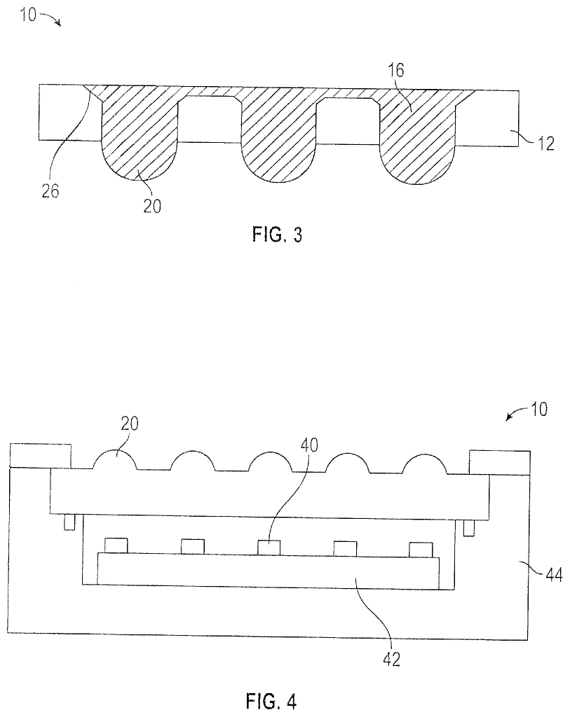

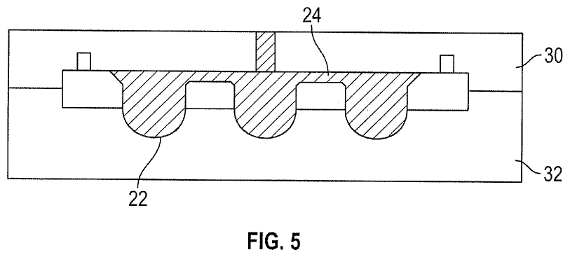

As can be seen by reference to FIG. 2, the plurality of apertures 14 can be arranged in an array of rows and columns, with each aperture 14 having a generally rectangular or square shape. A lens 20 or optical element that focuses or redirects light is formed generally within each of the apertures 14 during the overmolding step of fabrication. As shown most clearly in FIGS. 3 and 5, optical elements have curved surfaces 22 that help to refract light into a desired illumination pattern. The illustrated optical elements 20 are type V lens that produce a circular distribution having the same intensity at all angles. Type V lens are typically used to provide evenly distributed light such as in commercial parking lots. Other optical elements may be used for different applications.

As shown in FIG. 3, the overmolded silicone rubber body 16 includes a continuous, flat base portion 24 disposed within a recess 26 on a first side of frame 12 (that can face toward LEDs in a lighting fixture) and a plurality of optical elements projecting from the base portion 24 through and away from the apertures 14 at a second opposite side of the frame.

As indicated in FIG. 5, lens member 10 can be fabricated by placing frame 12 into a mold cavity defined by mold sections 30, 32, closing the mold and injecting silicone rubber into the mold cavity via sprue 34 to fill that portion of the cavity that is not occupied by the frame.

Shown in FIG. 5, is a lighting fixture having a plurality of LED dies 40 mounted on a substrate 42 having electrical terminals and leads for providing electrical power to the LEDs, a housing 44 and a lens member 10 defining a plurality of optical elements 20. Each optical element 20 is positioned to receive light from a corresponding underlying LED and focus or redirect the light into a desired illumination pattern. The frame portion 12 of lens member 10 can be provided with locator pins 50 that engage holes on the housing or other structure to facilitate rapid positioning and assembly.

While the present invention is described herein with reference to illustrated embodiments, it should be understood that the invention is not limited hereto. Those having ordinary skill in the art and access to the teachings herein will recognize additional modifications and embodiments within the scope thereof. Therefore, the present invention is limited only by the claims attached herein.

1. A lens member for an LED lighting fixture, comprising:
a planar frame having a plurality of apertures; and
an optically transparent silicone rubber overmolded onto a recess defined on a first side of the planar frame, the overmolded silicone rubber having a continuously flat base disposed within the recess and defining a plurality of optical elements, each optical element disposed within one of the apertures and shaped to focus or redirect light transmitted through the optical element.

2. The lens member of claim 1, wherein the planar frame has a flexural modulus of at least 375,000 psi.

3. The lens member of claim 1, wherein the planar frame is composed of a thermoplastic having a glass transition temperature greater than or equal to 145° C.

4. The lens member of claim 1, wherein the planar frame is composed of a transparent or translucent thermoplastic material.

5. The lens member of claim 1, wherein the planar frame is composed of a polycarbonate.

6. The lens member of claim 1, wherein the planar frame has a thickness of from 0.5 mm to 4 mm.

7. The lens member of claim 1, wherein the planar frame is composed of a metal.

8. The lens member of claim 1, wherein the planar frame has width and length dimensions from 2 inches to 7 inches.

9. An LED lighting fixture, comprising:
a plurality of LED dies mounted on a substrate; and
a lens member disposed over the LED dies and substrate for directing light from the LED dies into a desired illumination pattern, the lens member comprising a planar frame having a plurality of apertures and an optically transparent silicone rubber overmolded onto a recess defined on a first side of the planar frame, the overmolded silicone rubber having a continuously flat base disposed within the recess and defining a plurality of optical elements, each optical element disposed within one of the apertures and shaped to focus or direct light transmitted through the optical element from the LED dies, the lens member arranged over the LED dies such that each optical element is centered over a corresponding LED die.

10. The LED lighting fixture of claim 9, wherein the planar frame has a flexural modulus of at least 375,000 psi.

11. The LED lighting fixture of claim 9, wherein the planar frame is composed of a thermoplastic having a glass transition temperature greater than or equal to 145° C.

12. The LED lighting fixture of claim 9, wherein the planar frame is composed of a transparent or translucent thermoplastic material.

13. The LED lighting fixture of claim 9, wherein the planar frame is composed of a polycarbonate.

14. The LED lighting fixture of claim 9, wherein the planar frame has a thickness of from 0.5 mm to 4 mm.

15. The LED lighting fixture of claim 9, wherein the planar frame is composed of a metal.

16. The LED lighting fixture of claim 9, wherein the planar frame has width and length dimensions from 2 inches to 7 inches.

17. A process of making a lens member for an LED lighting fixture, comprising:
providing a planar frame having a plurality of apertures; and
overmolding onto a recess defined on a first side of the planar frame an optically transparent silicone rubber to form a member having a continuously flat base disposed with the recess and a plurality of optical elements, each optical element disposed within one of the plurality of apertures and shaped to focus or redirect light transmitted through the optical member.

18. The process of claim 17, wherein the planar frame is made by injection molding a thermoplastic material.

19. The process of claim 17, wherein the planar frame is made by progressive die stamping a metal sheet.
